(19) United States
(12) Patent Application Publication
(10) Pub. No.: US 2019/0131597 A1
(43) Pub. Date: May 2, 2019

(54) BATTERY PACK

(71) Applicants: Alex Oksengendler, Buffalo Grove, IL (US); Douglas Harriott, Melrose, MA (US)

(72) Inventors: Alex Oksengendler, Buffalo Grove, IL (US); Douglas Harriott, Melrose, MA (US)

(73) Assignee: OSRAM SYLVANIA Inc., Wilmington, MA (US)

(21) Appl. No.: 15/801,162

(22) Filed: Nov. 1, 2017

(51) Int. Cl. H01M 2/10; F21V 23/02; H01M 10/42; H01M 10/46; H01M 2/02; H01M 2/04

(52) U.S. Cl. CPC H01M 2/1016; F21V 23/023; H01M 10/425; H01M 2/0456; H01M 10/46; H01M 2/0245; H01M 2/1055; H01M 2/1094

(57) ABSTRACT

Techniques and architectures are disclosed for a ruggedized battery pack to provide power to an electric device or appliance. The battery pack includes a battery mounting plate having an elongated central portion and opposing offset end portions at each end of the central portion. The central portion is configured to receive one or more batteries and includes a reinforcement rib that extends longitudinally along a length of the central portion. The offset end portions include at least two bends that position a corresponding terminal portion of the mounting plate relative to the central portion. The batteries are attached to the mounting plate with a wrapping that surrounds at least a portion of the central portion and the batteries. The battery pack also includes a wiring harness attached to the batteries and including a strain relief assembly that prevents the wiring harness from being separated from the batteries.

### TECHNICAL FIELD

The present invention relates to power storage systems, and more particularly to battery packs used for providing electrical power to devices

### BACKGROUND

Battery packs provide a finite source of electrical power which can be used to operate an electrical device in areas where commercial power is not readily available. Typically, battery packs include several batteries or battery cells connected to one another to produce a desired output of electrical power. The batteries are electrically connected in a series or parallel fashion depending on the desired output of electrical power for the battery pack. The electrical power from battery pack is transmitted to the electrical device using a wiring harness attached to the batteries.

### SUMMARY

One example embodiment of the present disclosure provides a battery pack including a battery mounting plate having an elongated central portion and opposing offset end portions at each end of the elongated central portion, the central portion configured to receive one or more batteries and including a reinforcement rib, wherein the rib extends longitudinally along a length of the central portion of the mounting plate, and the offset end portions each including at least two bends that position a corresponding terminal portion of the mounting plate relative to the central portion; a wrapping that attaches the one or more batteries to the mounting plate, wherein the wrapping surrounds at least a portion of the central portion of the mounting plate and at least a portion of the one or more batteries; and a wiring harness connected to the one or more batteries and including a strain relief assembly, the assembly is configured to prevent the wiring harness from being separated from the one or more batteries. In some cases, the battery mounting plate is a single continuous plate and includes a plurality of reinforcement ribs that extend longitudinally along the length of the central portion of the mounting plate. In other cases, the reinforcement rib extends beyond the central portion of the mounting plate and into at least one of the opposing offset end portions of the mounting plate. In yet other cases, the length of the mounting plate is a maximum dimension of the battery pack. In some cases, the offset end portions include a first bend and a second bend, the first bend being in a first direction relative to the mounting plate and the second bend being in a second direction different from the first direction and relative to the mounting plate to position the corresponding terminal portion of the mounting plate in a first plane offset from but parallel to a second plane in which the central portion runs. In some such cases, the offset end portions extend along a width of the battery pack. In other cases, the wrapping includes a first layer of wrapping and a second layer of wrapping, the first layer of wrapping surrounds the one or more batteries and the second layer of wrapping surrounds the first layer of wrapping and the central portion of the mounting plate. In some such cases, the wrapping is shrink wrapping. In other such cases, the wrapping includes two or more layers of wrapping, and each layer of wrapping is applied in a direction different than a direction of a previous layer. In other cases, the strain relief assembly includes a grommet and a fastening element with a portion of the wiring harness located therebetween, the strain relief assembly transmits an applied force along the wiring harness in a non-linear direction relative to the one or more batteries. In some cases, the battery pack further includes a top cover attached to the mounting plate and positioned over the one or more batteries. In some such cases, the battery pack further includes a bottom cover attached to at least one of the mounting plate and the top cover, such that a portion of the bottom cover overlaps the top cover. In some such cases, the bottom cover is in contact with the mounting plate and further includes a plurality of locking features configured to engage openings within the top cover to maintain the bottom cover in contact with the top cover. In some cases, the battery pack further includes a power sensor to sense loss of main power and a switch to electrically connect the one or more batteries into a circuit so that one or more batteries can provide power.

Another example embodiment of the present disclosure provides a light fixture including a housing that includes one or more light sources; a driver disposed within the housing and operatively coupled to the one or more light sources; and a battery pack operatively coupled to the driver, the battery pack including a battery mounting plate having an elongated central portion and opposing offset end portions at each end of the elongated central portion, the central portion configured to receive one or more batteries and including a reinforcement rib, wherein the rib extends longitudinally along a length of the central portion of the mounting plate, and the offset end portions each including at least two bends that position a corresponding terminal portion of the mounting plate relative to the central portion; a wrapping that attaches the one or more batteries to the mounting plate, wherein the wrapping surrounds at least a portion of the central portion of the mounting plate and at least a portion of the one or more batteries; and a wiring harness connected to the one or more batteries and the driver, the wiring harness includes a strain relief assembly configured to prevent the wiring harness from being separated from the one or more batteries. In some instances, the battery pack further comprises a power sensor to sense loss of main power and a switch to electrically connect the one or more batteries into a circuit so that one or more batteries can provide power. In other instances, the battery mounting plate is a single continuous plate and includes a plurality of reinforcement ribs that extend longitudinally along the length of the central portion of the mounting plate. In yet other instances, the offset end portions include a first bend and a second bend, the first bend being in a first direction relative to the mounting plate and the second bend being in a second direction different from the first direction and relative to the mounting plate to position the corresponding terminal portion of the mounting plate in a first plane offset from but parallel to a second plane in which the central portion runs. In some instances, the strain relief assembly includes a grommet and a fastening element with a portion of the wiring harness located therebetween, the strain relief assembly transmits an applied force along the wiring harness in a non-linear direction relative to the one or more batteries. In other instances, the battery pack further includes a bottom cover attached to the mounting plate and a top cover, such that a portion of the bottom cover overlaps the top cover.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1A is a perspective view of a battery pack configured according to embodiments disclosed herein.

FIG. 1B is another perspective view of the battery pack of FIG. 1A according to embodiments disclosed herein.

FIG. 1C is an exploded view of the battery pack of FIG. 1A according to embodiments disclosed herein.

FIG. 1D is a top view of the battery pack 100 of FIG. 1A with a top cover removed according to embodiments disclosed herein.

FIG. 1E is an enlarged view of the strain relief assembly of FIG. 1D according to embodiments disclosed herein.

FIG. 2A is a perspective view of a battery mounting plate for the battery pack of FIG. 1A according to embodiments disclosed herein.

FIG. 2B is a partial side view of the battery mounting plate shown in FIG. 2A according to embodiments disclosed herein.

FIG. 3 is a perspective view of a top cover for the battery pack of FIG. 1A according to embodiments disclosed herein.

FIG. 4A is a top view of a bottom cover according to embodiments disclosed herein.

FIG. 4B is a cross-sectional view of the bottom cover shown in FIG. 4A according to embodiments disclosed herein.

FIG. 5 is a perspective view of a battery mounting plate for the battery pack of FIG. 1A according to embodiments disclosed herein.

FIG. 6A is a block diagram of a light fixture configured according to embodiments disclosed herein.

FIG. 6B is a block diagram of a light fixture configured according to embodiments disclosed herein.

FIG. 6C is a block diagram of a light fixture configured according to embodiments disclosed herein.

### DETAILED DESCRIPTION

Techniques and architectures are disclosed for a ruggedized battery pack to power an electric device or appliance (e.g., a light fixture). The battery pack of the present disclosure is scalable and customizable for any desired end use. For example, the battery pack can be connected to an existing light fixture within an area (e.g., an office or retail space or home) to configure the fixture as an emergency light fixture during a power outage, regardless the type and/or size of the light fixture. Thus, additional emergency lighting capability can be easily provided to the area without the expense of installing additional light fixtures. In an embodiment, the battery pack includes a battery mounting plate configured to receive one or more batteries. The battery mounting plate, in some examples, includes a reinforcement rib within a central portion of the battery mounting plate and opposing offset end portions at each end of the central portion. The reinforcement rib and offset end portions increase the strength of the battery mounting plate, and thereby reduce movement of the batteries positioned thereon relative to one another caused by bending and/or twisting of the battery mounting plate. The batteries are attached to the battery mounting plate with a wrapping (e.g., a heat shrink plastic wrap) or suitable bonding agent. A wiring harness is attached to the batteries and includes a strain relief assembly that prevents the wiring harness from being separated from the batteries. In some embodiments, the battery pack further includes a power sensor and switch arrangement. In such cases, in the event of power loss, the power sensor detects said power loss and controls one or more switches to connect the battery pack into the circuit being powered, thereby providing an emergency power backup source. Numerous embodiments will be appreciated.

As described above, battery packs provide a source of electrical power to a device, such as a laptop computer. A battery pack typically includes multiple batteries connected to one another using short strips of metal, such as interconnects, to transfer electrical power between adjacent batteries. Often times, however, deflection or movement of the batteries can damage the interconnects, and thereby cause the battery pack to no longer provide power. Battery movement can result, for example, from the battery pack being dropped or otherwise mishandled during shipment and/or installation. In addition, battery packs also fail when the wiring harness attached to the battery pack is unintentionally disconnected from the batteries. Particularly, pulling or pushing on the wiring harness can cause the electrical connections (e.g., soldered joints) between the wires and batteries to fail. Without the wiring harness connected to the batteries, the battery pack cannot transmit (or receive, in the case of rechargeable battery packs) electrical power.

Thus, and in accordance with an embodiment of the present disclosure, techniques and architectures are disclosed for a ruggedized battery pack to power an electric device. The battery pack includes a battery mounting plate configured to receive one or more batteries. The battery mounting plate, in some examples, can be a single continuous plate that includes one or more reinforcement ribs within a central portion of the battery mounting plate. The rib(s) increases the strength of the battery mounting plate to reduce movement of the batteries relative to one another caused by bending and/or twisting of the battery mounting plate. For instance, the reinforcement ribs can be positioned parallel to a maximum dimension of the battery pack (e.g., along its length) to increase stiffness of the battery mounting plate, and thus reduce or otherwise eliminate bending of the battery mounting plate between its two ends. In addition, the battery mounting plate can also include offset end portions that provide localized areas of strength within the battery mounting plate to increase the overall rigidity of the battery mounting plate.

The batteries are attached to the battery mounting plate with a wrapping or flexible bonding agent. In some example embodiments, the wrapping can be PVC plastic wrap or other shrink wrap material, which can be subsequently heated (e.g., using a heat gun) to form a tight seal around the battery mounting plate and batteries. The wrapping can surround both the battery mounting plate and the batteries, but this need not be the case in all embodiments. In addition, the wrapping can be a single layer or multiple layers. Multiple-layered wrappings can include layers of the same or different materials and applied onto the batteries in a pattern or sequence (e.g., alternating fashion), depending on a given application. A bonding agent can also be used with such wrappings, such as a flexible polymer. Alternatively, such a bonding agent can be used on its own, with a wrapping.

The battery pack further includes a wiring harness that is attached to the batteries and includes a strain relief assembly that prevents the wiring harness from being separated from the batteries. The wire harness, in some examples, can include two or more conductors and a connector that interfaces to the electrical device (e.g., a driver or ballast of a light fixture). In addition, the wiring harness includes a strain relief assembly that provides security to prevent damage to one or more conductors of the harness. In some examples, the strain relief assembly is a combination of a grommet within a top cover and a fastening element (e.g., a wire tie) attached to the battery mounting plate. The grommet and fastening element are offset from one another so that the portion of the wiring harness located therebetween forms a loop (e.g., an “S” shape). The loop (or slack) provides flexibility to allow the wiring harness to move relative to the battery pack without increasing tension and/or stress on the wires. The strain relief assembly prevents forces from being transmitted along the wiring harness in a direction that is linear to the batteries, which can cause separation of the wiring harness from the batteries. In some other embodiments, the strain relief assembly can include a service loop.

The battery pack, in some embodiments, can further include a power sensor and switching arrangement configured to automatically switch the batteries of the assembly into the given circuit to be powered, in response to a loss of mains power. In some embodiments, the sensor/switching arrangement is separate from but electrically connected to the battery assembly. In other cases, the sensor/switching arrangement is integrated with the battery assembly. This is noteworthy, because in such applications that battery pack can be electrically connected to a device (e.g., an existing light fixture) without further modification thereto. Another embodiment of the present disclosure discloses a light fixture with a battery pack as described herein. The light fixture can be any type of light fixture, such as 2×4 recessed troffers and flat panel lights. In some example embodiments, the light fixture includes a housing having one or more light sources. The light sources can be, for example, a strip of light emitting diodes (LEDs) or fluorescent light bulbs, depending on the application. The light fixture further includes a driver disposed in the housing and operatively coupled to the light sources. The driver is configured to regulate the voltage and current supplied to the light sources during operation of the light fixture. In addition, the light fixture further includes a battery pack, as previously described above, coupled to the driver so that light fixture can provide emergency lighting to an area. In some embodiments, the light fixture further includes a power sensor to monitor the electrical power of the light fixture. When the power sensor detects a loss of electricity at the light fixture, the sensor is further configured to enable the light fixture to operate using power supplied by the battery pack, for example by operating a switch. In some examples, the power sensor can be integrated into one of the driver or battery pack, depending on a given application. Numerous other battery pack applications will be apparent in light of the present disclosure.

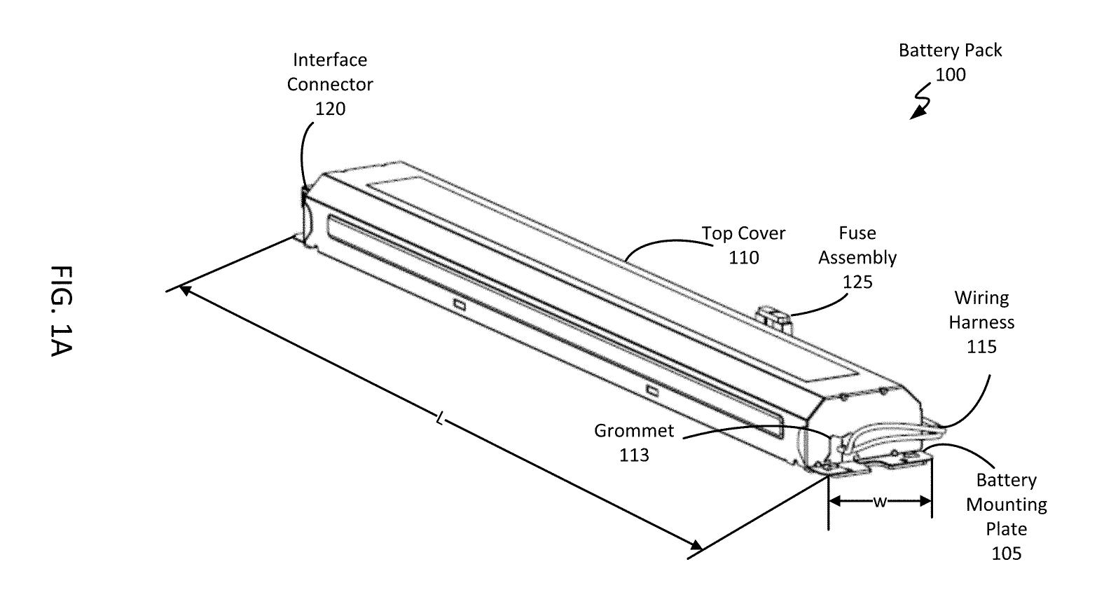

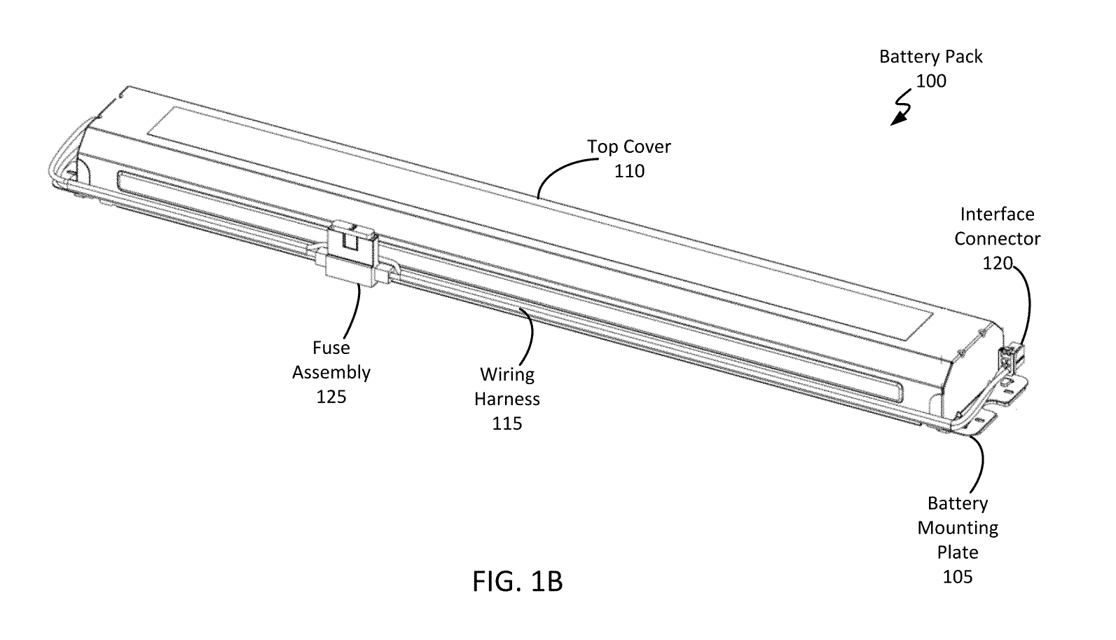

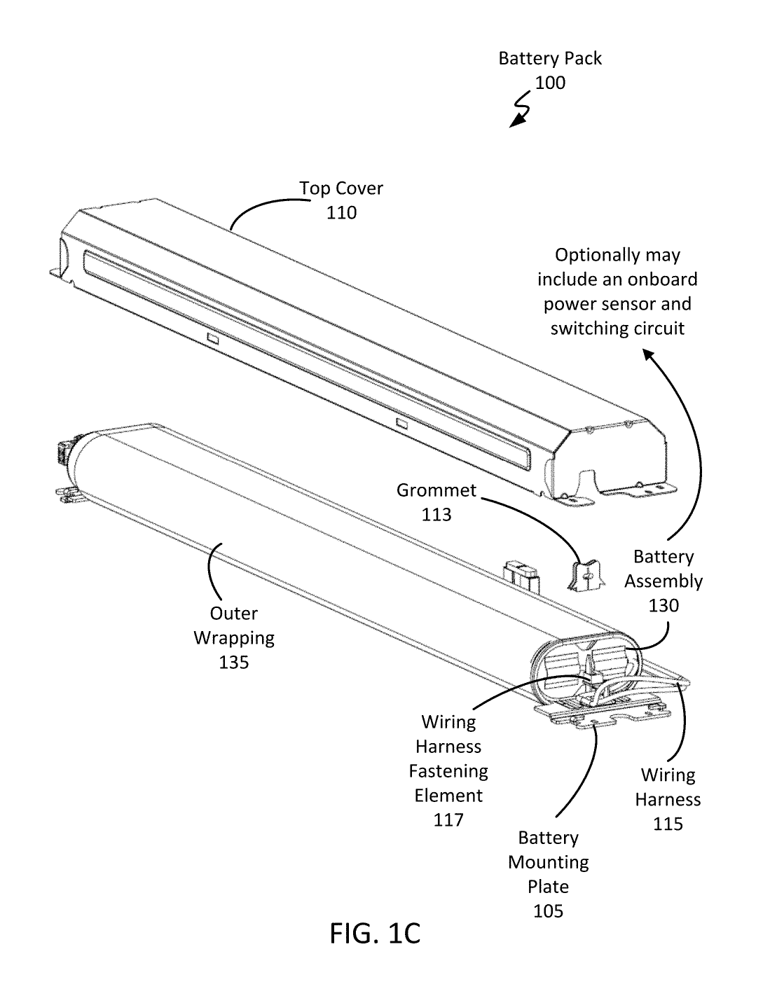

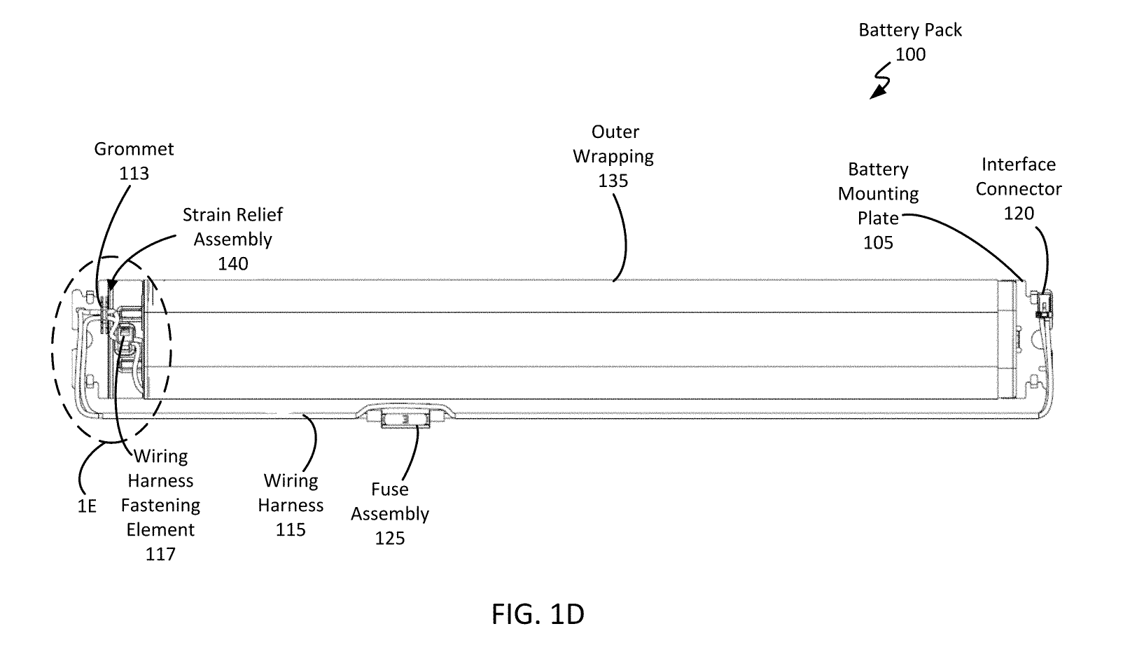

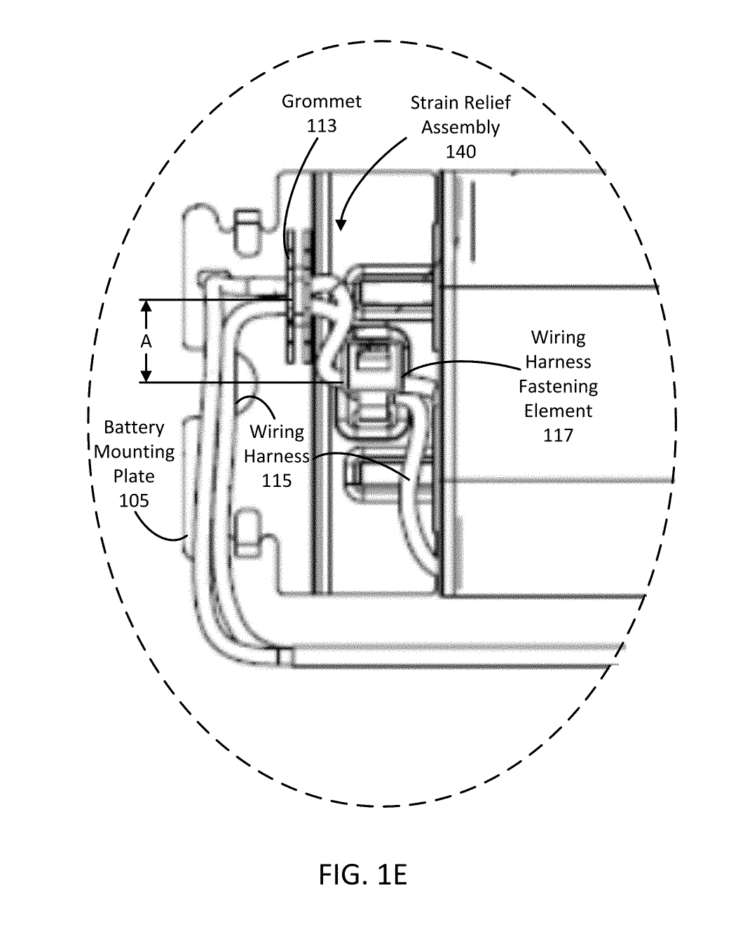

FIG. 1A is a perspective view of a ruggedized battery pack 100 configured in accordance with an embodiment of the present disclosure. FIG. 1B is another perspective view of the battery pack 100 of FIG. 1A. FIG. 1C is an exploded view of the battery pack 100 of FIG. 1A. FIG. 1D is a top view of the battery pack 100 of FIG. 1A with the top cover 110 removed. FIG. 1E is an enlarged view of the strain relief assembly of FIG. 1D. The ruggedized battery pack 100 can be efficiently manufactured and is customizable for particular end-use applications. For instance, the battery pack 100 can be constructed and arranged to be installed inside or outside the electrical device (e.g., a light fixture). In addition, the battery pack 100 can accommodate several batteries arranged in series with one another or in parallel with each other or both. To accommodate the various battery arrangements the form factor of the battery pack 100 can be customized depending on a given application. In general, the form factor of the battery pack 100 can be any size or shape sufficient to contain the batteries used to generate a desired output of electrical power. As can be seen, in some examples, the battery pack 100 can include a form factor having a shape similar to that of an electrical ballast so that the pack 100 can be installed within a light fixture (e.g., a 2×4 recessed troffers and flat panel lights). In addition, the battery pack includes a length “l” and a width “w” that can be varied during manufacture to accommodate a desired battery configuration. In some examples, the battery pack 100 can include a length “l” that is larger than a width “w”. The pack 100, in some other examples, includes the width “w” that is larger than the length “l”. In yet other examples, the battery pack 100 can include a length “l” and a width “w” that are equal to one another. As can be seen in FIGS. 1A-D, in this one example embodiment, the battery pack 100 generally includes a battery mounting plate 105 (hereinafter referred to as mounting plate 105), a top cover 110, a grommet 113, a fastening element 117, a battery assembly 130, a wrapping 135, and a strain relief assembly 140.

The mounting plate 105 supports the battery assembly 130. Generally speaking, the mounting plate 105 provides a rigid surface on which to mount the batteries. In particular, the mounting plate 105 is configured to limit or otherwise eliminate movement (e.g., bending or deflection) of the battery assembly 130 that can damage the connection between batteries thereon. The movement of the battery cells (batteries) increases the stress at joints between the batteries causing them to fail and the battery pack 100 to no longer transmit electrical power. In addition, the mounting plate 105 can be manufactured from metals and composite materials having mechanical properties associated with high strength materials. For instance, the mounting plate 105 can be made from materials having a Young's modulus within a range of 200 Gigapascals (GPa) to 580 GPa. More particularly, the mounting plate 105, in some examples, can be manufactured from carbon steel, stainless steel, carbon fiber and reinforced plastics, to name just a few example materials. In other example embodiments, the mounting plate 105 can be manufactured from other metallic materials, such as aluminum. In this one specific example, the mounting plate 105 can include a thickness in the range of 1.10 to 1.25 mm. The mounting plate 105 can further include a coating (e.g., an application of paint) to provide a desired surface finish and/or protect the mounting plate 105 from the environmental elements (e.g., rain or dust or dirt). Additionally, the mounting plate 105, in some examples, is further configured to receive one or more cover plates. As can be seen, in this one example, the mounting plate 105 is configured to receive the top cover 110. In some applications, an optional bottom cover can also be attached to the mounting plate 105 for applications in which the battery pack 100 is not installed within the electrical device, as will be described further herein. In some such embodiments, the top cover 110 and a bottom cover (e.g., bottom cover 400) provide a sealed compartment to protect the batteries therein from moisture and the environment.

As shown in FIG. 1C, attached to the mounting plate 105 is a top cover 110 that protects the battery assembly 130 from environmental elements and damage caused by impact forces when the battery pack 100 is dropped onto a hard surface, such as a floor or table. Together, the mounting plate 105 and top cover 110, in some examples, can surround the entire battery assembly 130. In some other examples, the mounting plate 105 and top cover 110 may surround a portion of the battery assembly 130. The top cover 110 can be manufactured from the materials as described above for the mounting plate 105. In some examples, the cover 110 and mounting plate 105 are manufacture from the same material. The cover 110 and mounting plate 105, in other examples, are different materials. In addition, the cover 110, in some examples, can have a thickness ranging between 0.5 to 1.0 mm. The top cover 110 can further include a coating (e.g., an application of paint) to provide a desired surface finish and/or to protect the cover 110 from the environmental elements.

Installed within the top cover 110 is a grommet 113 configured to protect and/or insulate one or more wires of the wiring harness 115 as the wires pass through the cover 110. In general, the grommet 113 is a flexible component that can serve as a fastening, support, and/or reinforcement for wires of the wiring harness 115. The grommet 113, in some examples, is part of strain relief assembly 140, as described further herein. The grommet 113 can be an eyelet of firm material to insulate or protect wires of the wiring harness 115 being passed through the cover 110. As can be seen in FIG. 1C, the grommet 113, in some example embodiments, is configured to be received within a cut-out or opening within the top cover 110, as will be described further herein. In other examples, the grommet 113 can be attached to the mounting plate 105. The grommet 113 can be made out any non-metallic material, for example rubber (e.g., styrene butadiene, neoprene, isoprene rubber) or polymeric materials. The grommet 113 can be any size sufficient to receive the wires of the wiring harness 115.

Passing through the grommet 113 is a wiring harness 115. The wiring harness 115 is configured to transmit electrical power from the batteries to an electrical device (e.g., a light fixture). In general, the wiring harness 115 is an assembly of electrical cables or wires that transmit electrical signals or power. In this example, the wiring harness 115 includes two wires for transmitting electrical power. The wires, in some examples, are #18-gauge copper wires having 32/33 stranded construction. In some cases, the wires can be encased in a shrink tube that protects the wires from damage. The wiring harness 115 can be attached to the battery assembly 130 at one end (e.g., with a soldered joint) and includes an interface connector 120 at the other end. The interface connector 120 electrically connects the battery pack 100 to the electrical device to transfer electrical power thereto. In some examples, the interface connector 120 is a female socket receptacle. The wiring harness 115 can further include a fuse assembly 125 that provides overcurrent protection to the electrical device connected to the battery pack 100. In particular, the fuse assembly 125 includes a fuse that is configured to interrupt the current flowing through the wiring harness 115 if the battery pack 100 malfunctions (e.g., providing an excessive amount of current through the harness 115). In some examples, the fuse holder is a SCOTCHLOK® 972 self-stripping in-line blade type fuse holder that is installed between the power source (e.g., the batteries) and the interface connector 120. The fuse, in some examples, can be a 32 Volt (V), 3 Ampere (A) fast blow fuse. In addition, the wiring harness 115 can be attached or otherwise secured to the mounting plate 105 using a fastening element 117 of the strain relief assembly 140, as describe further herein. In some examples, the fastening element 117 can be a nylon locking tie, such as a tie-wrap. Numerous other wire harness configurations will be apparent in light of the present disclosure.

As shown in FIG. 1C, the wiring harness 115 is connected to the battery assembly 130. The battery assembly 130 is configured to generate or otherwise produce electrical power that used to operate the electrical device. In general, the battery assembly 130 includes one or more batteries (or battery cells) assembled in a fashion to produce a desired output of electrical power. In this example embodiment, the battery assembly 130 may include 16 batteries (e.g., C5 batteries) inside a metal housing and surrounded by a layer of wrapping. In other examples, the battery assembly 130 can include more or fewer battery cells, depending on a particular application. The individual batteries of the battery assembly 130 can be arranged in series or parallel (or both) depending on a given application. In this one example, the battery assembly 130 is a 2×8 assembly, in which two sets of eight batteries are connected in series with one another. Between each battery is an interconnect that transfers electrical power from one battery to another. In some examples, the interconnect is a strip of metal (e.g., a metal-welded staple) that is attached to one end of two batteries. The interconnect provides electrical conductivity between the two adjacent batteries. The number of interconnects within the battery assembly 130 is dependent on the number of batteries and the battery configuration for a given application. Additionally, any type of battery can be installed in the battery pack 100. The battery assembly 130, in some examples, can include battery types, such as nickel-cadmium, alkaline, and lithium-ion, to name a few battery examples. Additionally, the battery pack 100 can accommodate different sized batteries. For instance, the battery assembly 130, in some examples, can include C-sized batteries. In other examples, the batteries can include a size of A, AA, AAA, or D, to name a few example sizes. Furthermore, the batteries of the battery assembly 130 may be rechargeable or non-rechargeable batteries, depending on a given end use of the battery pack 100. For instance, battery packs that provide emergency power to a light fixture, may include rechargeable batteries so that the packs 100 can be used for more than one emergency.

In some embodiments, the battery assembly 130 is attached or otherwise secured to the mounting plate 105 with an outer wrapping 135 (herein after referred to as wrapping 135). The wrapping 135, in some examples, surrounds the battery assembly 130 and a central portion of the mounting plate 105, as shown in FIG. 1C. Note that in such an arrangement, the battery assembly 130 is not in contact with the top cover 110 or optional bottom cover. As can be seen, the wrapping 135 can be applied to the battery assembly 130 and mounting plate 105 in a direction normal to the length “l” of the mounting plate 105, such that the ends of the battery assembly 130 are exposed to allow electrical connections to be made to the assembly 130. In addition, the wrapping 135 can be a single layer or multiple layers of material. For instance, the wrapping 135 can include an inner layer of wrapping that surrounds all or a portion of the battery assembly 130. Surrounding the inner layer is an outer layer of wrapping that surrounds both the inner layer of wrapping and at least a portion of the central portion of the mounting plate 105. If the wrapping 135 includes multiple layers of material, the individual layers of wrapping can be of the same or different materials. In some examples, the wrapping 135 can include multiple layers of material wrapped in a sequence or pattern. For instance, the wrapping 135 can include a first layer (e.g., a previous layer) applied in a first direction (e.g., at 45 degrees towards the end at which the wiring harness 115 is attached to the battery assembly 130) and a second layer (e.g., a subsequent layer) applied to the first layer in a second direction different from the first direction (e.g., at 45 degrees towards the end adjacent to the interface connector 120). Furthermore, the wrapping 135 can be manufactured from a number of materials including plastic, fiber, or composite materials. In some examples, the wrapping 135 is made from shrink wrap (e.g., a PVC plastic), which can be subsequently heated (e.g., using a heat gun) to melt the wrapping, and thereby form a tight packaging around the battery assembly 130 and mounting plate 105. In some other examples, the battery assembly 130 can be secured to the mounting plate 105 using tape (e.g., electrical tape). The wrapping 135, in some other examples, may be applied to the battery assembly 130, but not the mounting plate 105. In such applications, the wrapped battery assembly 130 can be secured to the mounting plate 105 using any one of adhesives, straps, or brackets (or combination thereof). As previously explained a bonding agent can also be used to secure the battery assembly 130 to the mounting plate 105.

The battery pack 100 also includes a strain relief assembly 140 that prevents the wiring harness 115 from being disconnected from the battery assembly 130. Generally speaking, the strain relief assembly 140 includes a portion of the wiring harness 115 (e.g., a loop of wire) that provides flexibility to prevent damage to one or more wires of the harness 115. In this one example, the strain relief assembly 140 comprises the grommet 113 and fastening element 117 that secures a portion of the wiring harness 115 located therebetween to the mounting plate 105, as shown in FIGS. 1D-E. As can be seen, the grommet 113 and fastening element 117 are off-set from one another (e.g., distance “A”) so that the portion of the wiring harness located in between is in the shape of an “S”. This is particularly noteworthy, because a force applied to the wiring harness 115 is not transmitted in-line with or otherwise linear to the location at which the wiring harness 115 is attached to the battery assembly 130. Rather, the force is transmitted in a direction normal to the applied force (e.g., in a direction towards the fastening element), and thus stress is not applied to the wire connections at the battery assembly 130. Note that the portion of the wiring harness 115 located between the grommet 113 and fastening element 117 is slack or otherwise not tightly held in place. Thus, when a force is applied to the wiring harness 115, the slack allows the harness 115 to move in response to the applied force without damaging the wire connections at the battery assembly 130. Once the slack is taken up, the grommet 113 and fastening element 117 redirect the force in a non-linear direction relative to the battery assembly 130. Additionally, the fastening element 117 provides a clamping force on the wiring harness 115 so that the wires can no longer move once the slack is taken. In some other examples, the portion of the wiring harness 115 between the grommet 113 and fastening element 117 may include a service loop.

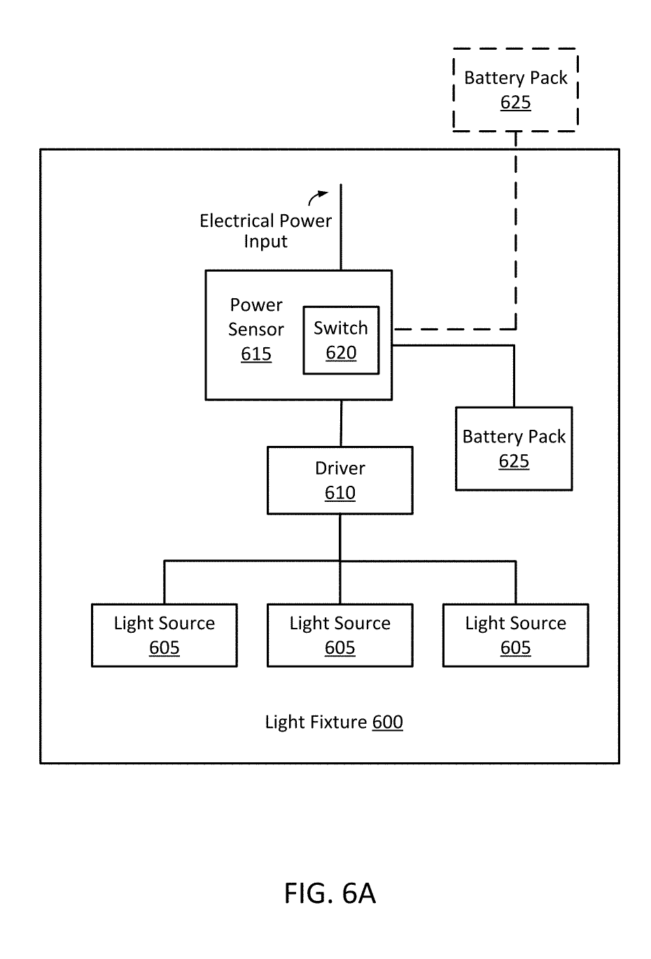

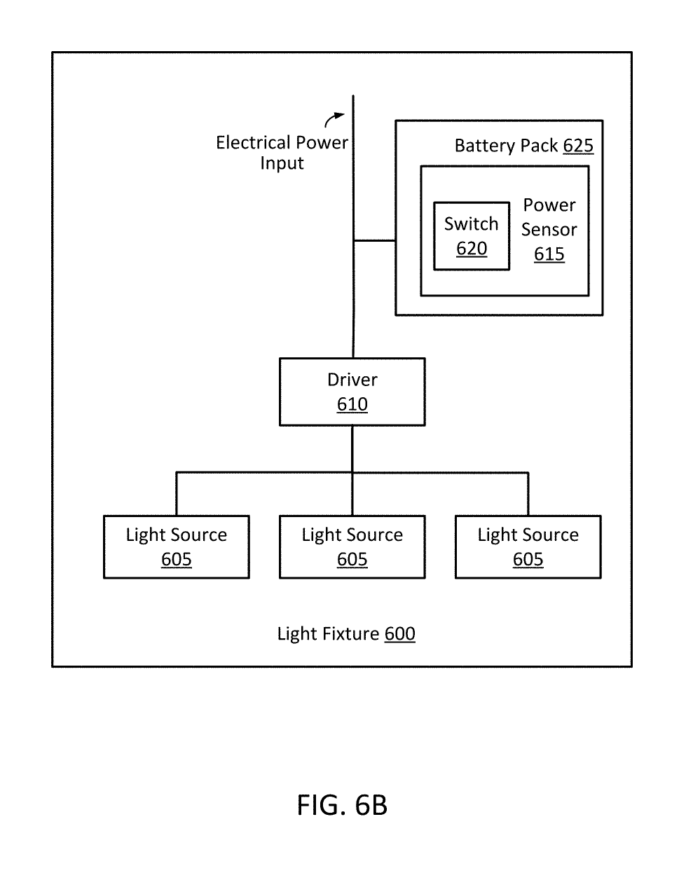

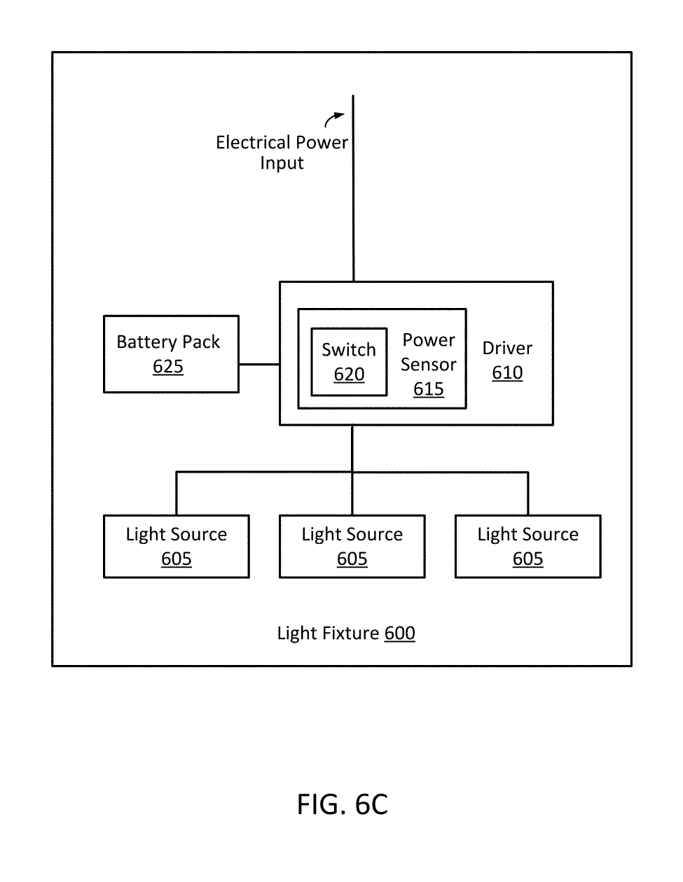

As previously explained, the battery pack 100 may further include an onboard power sensor and switching arrangement configured to automatically switch the batteries of the assembly 130 into the given circuit to be powered, in response to a loss of mains power. In some embodiments, the sensor/switching arrangement is separate from but electrically connected to the battery assembly 130. One such example application is described herein in relation to FIG. 6A. In other cases, the sensor/switching arrangement is integrated with the battery assembly 130 so that the battery pack 100 can be electrically connected to a device without further modification thereto. An example of such an application is described further herein in relation to FIG. 6B.

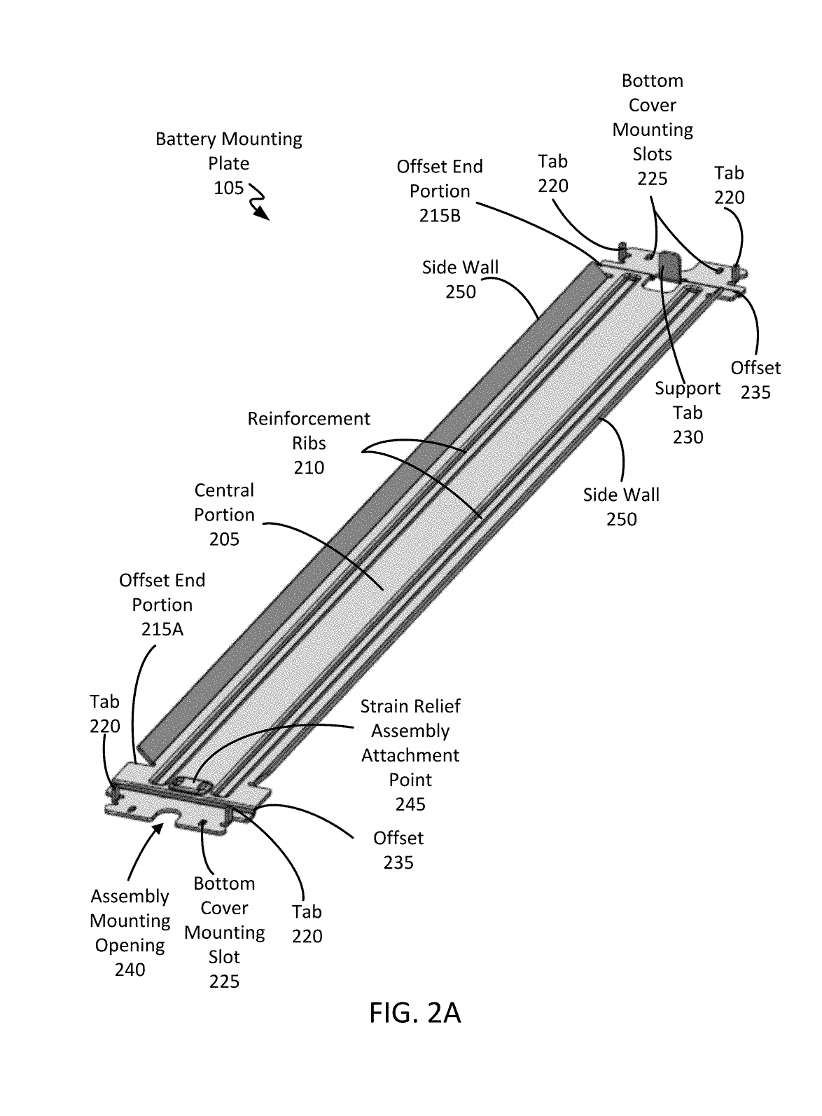

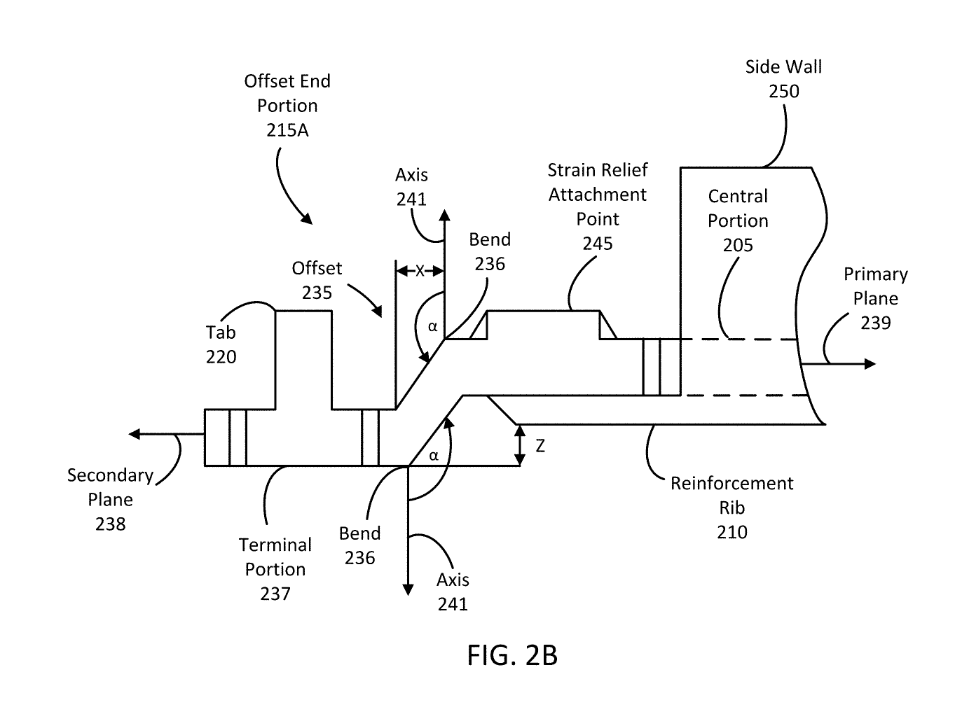

FIG. 2A is a perspective view of a mounting plate 105 for the battery pack 100 of FIG. 1A, in accordance with an embodiment of the present disclosure. FIG. 2B is a partial side view of the mounting plate 105 shown in FIG. 2A. As previously described above, the mounting plate 105 provides a rigid surface on which to mount the battery assembly 130. To improve mechanical characteristics, such as stiffness or impact resistance, of the battery pack 100 the mounting plate 105 can include features that can improve the overall strength of the battery pack 100. For instance, the mounting plate 105 can be a single piece of material, such as a carbon steel plate. This unitary construction of the mounting plate 105 increases its overall stiffness because the mounting plate 105 does not include joints (or connections) that are more likely to deflect or otherwise bend under an applied load. To accommodate various battery configurations, the mounting plate 105 can be manufactured from an over-sized piece of material (e.g., plate or sheet metal stock) and then cut or stamped into a shape having a desired size. In this one example, the mounting plate 105 includes a central portion 205, offset end portions 215A and 215B (collectively end portions 215) and side walls 250.

The mounting plate 105 includes a central portion 205 configured to receive and support the battery assembly 130. In addition, the central portion 205 also supports the end portions 215 and side walls 250, as described further herein. The central portion 205 can have any size sufficient to receive the battery assembly 130. As can be seen in FIG. 2A, in some examples, the central portion 205 is configured to support batteries arranged in a 2×8 configuration. In other examples, the central portion 205 can support a configuration of batteries, such as 12×1, 3×5, 4×4, or 1×10, just to name a few other example configurations.

Within the central portion 205 is at least one reinforcement rib 210 (hereinafter referred to as rib 210) that reduces or otherwise eliminates bending (or deflection) of the mounting plate 105. In general, the rib 210 can be a recessed or raised feature that increases the stiffness or rigidity of the central portion 205. Note that when recessed, the rib 210 can be configured to receive a lower portion of the battery assembly 130 to allow the assembly 130 to be seated onto the mounting plate 105. In other words, the rib 210 can allow the rounded surface of the batteries to have two points of contact with the mounting plate 105 rather than a single point of contact. Thus, batteries with two more points of contact with the central portion 205 can be more securely attached thereto because the batteries are more stable and less likely to move from side to side. In addition, the rib 210 can be positioned in any direction along the central portion 205. For instance, in some examples, the rib 210 can be positioned in a direction parallel to a maximum dimension of the mounting plate 105 (e.g., along its length as shown in FIG. 2A). In some examples, the rib 210 can extend into one or both end portions 215, but this need not be the case in all instances. As can be seen, the central portion 205 may include multiple ribs 210. In some examples, the multiple ribs 210 can be positioned in the same direction relative to one another (e.g., in parallel). In instances where the there is no maximum dimension (e.g., length is equal to width), the ribs 210 can be arranged normal to another. In some examples, the ribs 210 can intersect one another in a cross-hatch pattern. Furthermore, the ribs 210 can be continuous or non-continuous along a given dimension of the mounting plate 105.

Attached to the central portion 205 are end portions 215 that are configured to secure the battery pack 100 to an object (e.g., an electrical device, such as a light fixture) or a structure (e.g., a wall or ceiling). The battery pack 100 can be secured to the object (or structure) in any number of ways, including with fasteners, adhesives, straps, and brackets, to name a few attachment examples. To this end, the end portions 215 can be configured to interface with the object to secure the battery pack 100 in several different fashions. For instance, in some examples, the end portions 215 can include an assembly mounting opening 240 configured to receive a fastener (e.g., a bolt, screw or machine screw) to attach the battery pack 100 to the object. In other cases, the end portions 215 can engage tabs, brackets, or clips (or a combination thereof) disposed on the object to secure the battery pack 100 thereto. In addition, the offset end portions 215, in some examples, are configured to position a bottom cover at a distance “Z” from the central portion to provide a clearance between the bottom cover and rib 210. The clearance enables the bottom cover to be attached to the mounting plate 105 without creating an interference between the rib 210 and the bottom cover that could prevent attachment of the bottom cover to the mounting plate 105.

Additionally, the end portions 215 can be further configured to receive other components of the battery pack 100, such as the top cover 110. For instance, the end portions 215, in some examples, include one or more tabs 220 to secure the top cover 110 to the mounting plate 105. In this example configuration, the tabs 220 are positioned on the end portions 215 so that the tabs 220 align with openings in the top cover 110 to position the cover 110 onto the mounting plate 105. With the top cover 110 on the mounting plate 105, the tabs 220 can be crimped, folded, or otherwise bent over to prevent removal of the top cover 110 from the mounting plate 105. Additionally, the end portions 215, in some examples, further include one or more mounting slots 225 for mounting an optional bottom cover to the mounting plate 105, as will be described further herein. In addition, one of the end portions 215A or 215B, in some examples, can further include one or more support tabs 230 that prevent movement of the battery assembly 130. As can be seen in FIG. 2A, in this one example embodiment, the end portion 215B includes a support tab 230 that is configured to prevent movement of the battery assembly 130 in a direction along the length of the battery pack 100. As shown, the support tab 230 can extend along some of the end portion 215B, but this may not be the case in every application. In some other examples, multiple support tabs 230 can be located on one or both end portions 215, depending on a given application.

The end portions 215, in some examples, can also provide improved strength and rigidity of the mounting plate 105. As can be seen, in some examples, the end portions 215 can be integrated with the central portion 205, as shown in FIGS. 2A-B, to increase the overall rigidity of the mounting plate 105. In addition, the end portions 215 can include an offset 235 that provides additional strength to localized area of the mounting plate 105. For instance, the offset 235 can include two bends 236 that position a terminal portion 237 of the end portions 215 (e.g., a portion of the end portions 215 that includes tabs 220) within a secondary plane 238 and below and parallel to a primary plane 239 of the central portion 205. In more detail, the bends 236 can be located a distance “X” from each other. In this one specific embodiment, distance “X” is 2.1 mm. Distance “X”, in some other examples, can be longer or shorter depending on a given application. The bends 236 can be at an angle relative to the mounting plate 105. For instance, the bends can be formed within the end portions 215 so that they are at angle “α” relative to an axis 239. In some examples, angle “α” can be 145 degrees from the axis 241 (or in other words 55 degrees from a top or a bottom surface of the mounting plate 105). In other examples, the angle “α” can be 100, 110, 120, 135, 150, or 165 degrees, to name only a few angle configurations. In some other examples, the offset 235 positions the terminal portion 237 within the secondary plane 238 that is coplanar with to or above the primary plane 239 of the central portion 205. In addition, the offset 235, in some examples, can extend along an entire length of the end portions 215. The offset 235, in some other examples, may extend along a portion of the end portions 215.

As shown in FIG. 2A, the end portions 215 can further include a strain relief assembly attachment point 245 (hereinafter referred to as attachment point 245) that secures the wiring harness 115 to the mounting plate 105. General speaking, the attachment point 245 can be a portion of the end portions 215 configured to receive a connector or fastener (e.g., fastening element 117) that holds or otherwise retains the wires of the wiring harness 115 in place relative to the battery assembly 130. The attachment point 245, in some examples, is positioned offset from or otherwise not aligned with the grommet 113 so that a strain relief assembly 140 can be formed therebetween. As can be seen, the attachment point 245, in some examples, is located on the end portion 215A and between ribs 210 of the mounting plate 105. Numerous other attachment point configurations will be apparent in light of the present disclosure.

The central portion 205 is also attached to side walls 250 that are configured to further support the battery assembly 130 to prevent lateral movement of the batteries. As can be seen in FIG. 2A, in some examples, the side walls 250 can extend along an entire length of the central portion in a continuous fashion. In other examples, the side walls 250 may only extend part of the way along the central portion 205 (e.g., about a middle of the central portion 205). The side walls 250 may also extend along the central portion 205 in a non-continuous fashion, such that one or more portions of the battery assembly 130 is in partial contact with the side walls 250. In addition, the side walls 250 can be positioned in any direction relative the central portion 205 so long as the side walls 250 restrain lateral movement of the battery assembly 130 and do not interfere with installation of the top cover 110 and optional bottom cover. As can be seen in FIG. 2A, the side walls 250 can be positioned at an angle relative to the central portion 205. The side walls 250, in some examples, can be positioned at an angle of 45 degrees relative to the central portion 205. In other examples, the side walls 250 can be positioned at an angle, such as 10, 25, 30, 50, 60, 75 and 90 degrees, relative to the central portion 205. Numerous other side wall configurations will be apparent in light of the present disclosure.

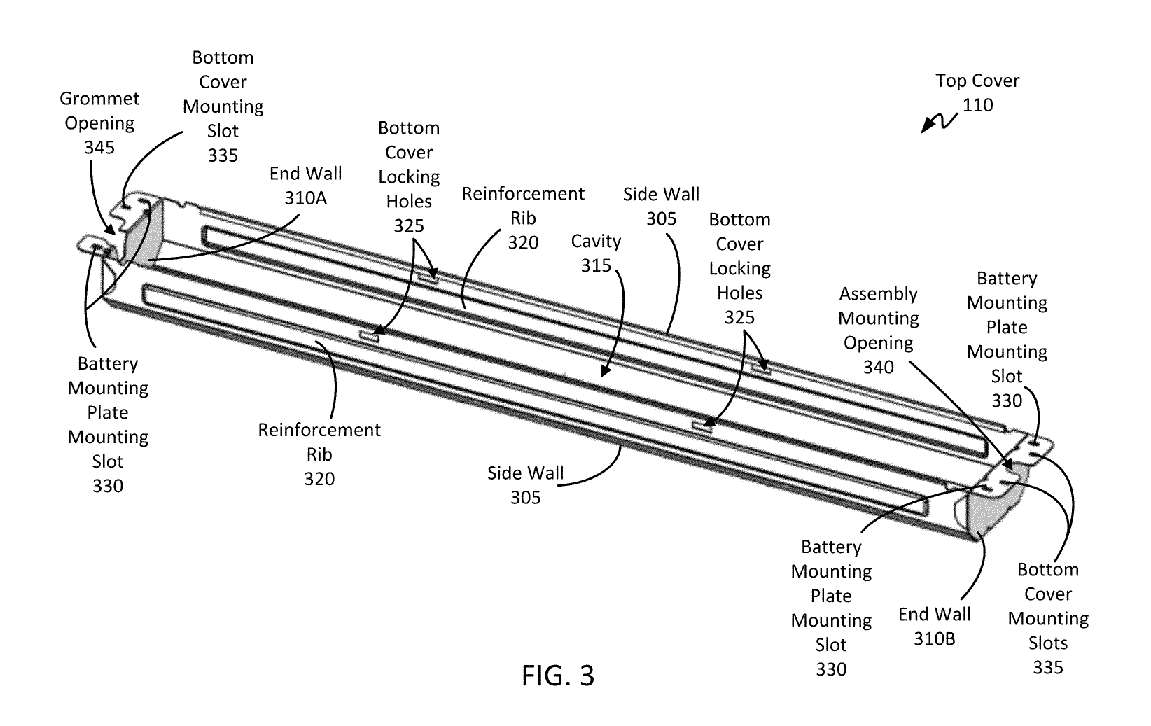

FIG. 3 is a perspective view of a top cover for the battery pack 100 of FIG. 1A, in accordance with an embodiment of the present disclosure. As previously described herein, the top cover 110 is positioned onto the mounting plate 105 to protect the battery assembly 130. As can be seen, in some examples, the top cover 110 includes side walls 305 and end walls 310A and 310B (collectively 310). Together, the side walls 305 and end walls 310 define a cavity 315 in which to receive the battery assembly 130.

As can be seen, in some examples, the side walls 305 can include additional features that can improve the strength of the battery pack 100 or allow additional components to be attached thereto. For instance, the side walls 305 can include a reinforcement rib 320 (hereinafter referred to as rib 320) that is configured to stiffen or otherwise strengthen the top cover 110. As can be seen, the rib 320 can be positioned in a direction parallel to a maximum dimension of the top cover 110 (e.g., along its length as shown in FIG. 3). The rib 320 can be a continuous rib, as shown in FIG. 3, or a non-continuous rib (e.g., a group of rib segments). In addition, the side walls 305, in some examples, can further include bottom cover locking holes 325 for attaching an optional bottom cover to the battery pack 100. The holes 325 can be any size sufficient to receive the locking features on the bottom cover. In some examples, the holes 325 can have a length of 9.0 mm and a height of 3.0 mm. The locking holes 325 will be described further herein in relation to the bottom cover 400.

Attached to the side walls 305 are end walls 310 that are configured to attach the top cover 110 to the mounting plate 105 (and optionally to a bottom cover). As can be seen in FIG. 3, the end walls 310, in some examples, include mounting plate mounting slots 330 used to secure the top cover 110 to the mounting plate 105. When the top cover 110 is positioned onto the mounting plate 105, the slots 330 receive tabs 220 of the mounting plate 105. The tabs 220 can be manipulated (e.g., crimped or folded over) to secure the top cover 110 to the mounting plate 105. In some examples, the slots 330 can include a width of 2.0 mm and a length of 4.5 mm. In addition, the end walls 310, in some examples, can further include bottom cover mounting slots 335 that are utilized to attach an optional bottom cover to the battery pack 100, as described further herein.

The end walls 310, in some examples, can further be configured to allow the battery pack 100 to be attached to an object (e.g., a light fixture) or a structure (e.g., a floor, wall, or ceiling). As previously described, the battery pack 100 can be secured to the object (or structure) in any number of ways. To this end, the end walls 310 can be configured to receive or otherwise interface with the object or structure to secure the battery pack 100 thereto. For instance, in some examples, the end walls 310 can include a mounting opening 340 configured to receive a fastener (e.g., a bolt, screw or machine screw) to attach the battery pack 100 to the object. In other cases, the object or structure can include a tab or bracket disposed thereon and configured to receive the end wall 310 to secure the battery pack 100 to the object (or structure).

Additionally, at least one of the end walls 310A and 310B is further configured to allow the wiring harness 115 to pass through the cover 110. For instance, in some examples, the end wall 310A can further include an opening 345 in which to receive the grommet 113. The opening 345 is configured so that the grommet 113 can be slid or otherwise snapped into the opening 345. As can be seen, the opening 345 is positioned closer to one side of the end wall 315A than the other to position the grommet 113 offset from the fastening element 117 to form the strain relief assembly 140, as previously described herein.

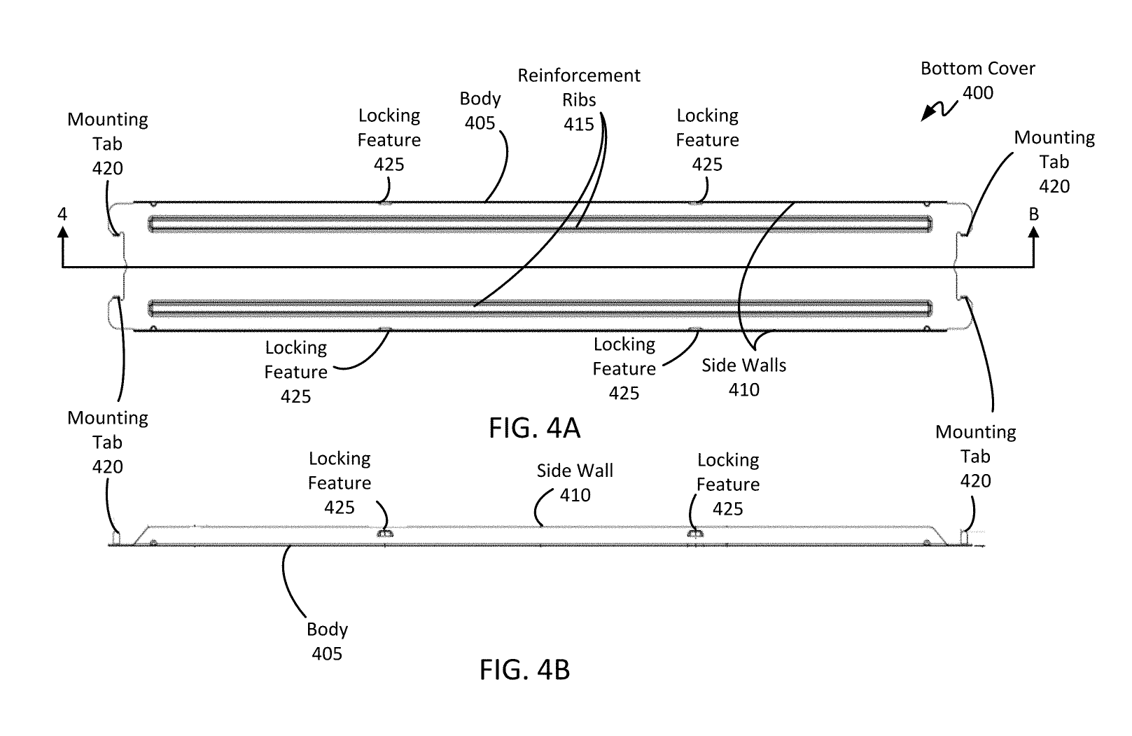

FIG. 4A is a top view of an optional bottom cover 400, in accordance with an embodiment of the present disclosure. FIG. 4B is a cross-sectional view of the bottom cover 400 shown in FIG. 4A. As previously described above, the battery pack 100 of the present disclosure can be installed within an electric device (e.g., a light fixture). However, the battery pack 100 of the present disclosure is not so limited. In some applications, the battery pack 100 can be positioned external to the electric device, such that the pack 100 is positioned adjacent to the device, for example on or against a surface of a wall or table adjacent thereto. Thus, the battery pack 100, in some embodiments, may further include a bottom cover 400 to improve an aesthetic appearance of the pack 100. Additionally, the bottom cover 400 can also increase rigidity and stiffness of the battery pack 100 by providing another layer of material beneath the mounting plate 105. In some examples, the bottom cover 400 can also further secure the top cover 110 to the mounting plate 105 to prevent separation of battery pack components in response to an impact force (e.g., dropping the battery pack 100 onto a hard surface). As can be seen in FIGS. 4A-B, the bottom cover 400, in some examples, includes a body 405 and side walls 410. In general, the body 405 provides aesthetic appearance so that the battery pack 100 can located outside or otherwise external to the electric device (e.g., on a person's desk). The cover plate 400 can be manufactured from the materials as described above for the mounting plate 105. In some examples, the cover plate 400, mounting plate 105, and top cover 110 are manufacture from the same material. The cover plate 400, in other examples, can be made from a material that is different than the material of the mounting plate 105 and/or top cover 110 to provide a unique or aesthetically pleasing appearance. In addition, the bottom cover 400, in some examples, can have a thickness ranging between 0.5 to 1.0 mm. The cover plate 400 can further include a coating as previously described herein in relation to the mounting plate 105.

As shown in FIG. 4A, the body 405 includes a reinforcement rib 415 (hereinafter referred to as rib 415) that reduces or otherwise eliminates bending of the bottom cover 400. In general, the rib 415 can be a recessed or raised feature that increases the stiffness or rigidity of the bottom cover 400. In addition, the rib 415 can be positioned in any direction along the body 405. For instance, in some examples, the rib 415 can be positioned in a direction parallel to a maximum dimension (e.g., along its length as shown in FIG. 4A). As can be seen, the body 405 may include multiple ribs 415. In some examples, the multiple ribs 415 can be positioned in the same direction relative to one another (e.g., parallel to one another). In instances where the there is no maximum dimension of the bottom cover 400 of the bottom cover 400 (e.g., length is equal to width), the ribs 415 can be constructed and arranged normal to one another. In some examples, the ribs 415 can intersect one another in a cross-hatch pattern. Furthermore, the ribs 415 can be continuous or non-continuous along a given dimension of the body 405, depending on the application.

In some examples, attached to the body 405 is a mounting tab 420 configured to secure the bottom cover 400 to the mounting plate 105. In such instances, when the bottom cover 400 is positioned onto the mounting plate 105, the mounting tab 420 passes or otherwise extends through the slots 225 of the mounting plate 105 and slots 335 of the top cover 110. Once inserted into the slots 225 and 335, the mounting tab 420 can be manipulated (e.g., crimped or folded over), such that the mounting tab 420 can no longer be withdrawn from the slots 225 and 335. In other words, once the mounting tab 420 is inserted and crimped, the bottom cover 400 is secured to both the mounting plate 105 and top cover 110. To assemble the bottom cover 400 to the mounting plate 105 in the manner described above, the length of the mounting tab 420 can be greater than the combined thickness of the mounting plate 105 and top cover 110. In some examples, the mounting tab 420 includes a length of 6.3 mm. In other instances, the mounting tab 420 may engage the mounting plate 105, but not the top cover 110. In addition, the body 405 can include more than one mounting tab 420. As can be seen in FIGS. 4A-B, in some examples, the body 405 includes four mounting tabs 420. The number of mounting tabs 420 can vary depending on several factors, including for example the overall length and width of the bottom cover 400. In some other examples, the body 405 may not include mounting tabs 420. Rather, the bottom cover 400 may be attached to the mounting plate 105 in other ways, including using fasteners (e.g., bolts or screws), adhesives, straps, and/or brackets, to name just a few attachment examples.

Attached to the body 405, in some examples, are side walls 410 that align and secure the bottom cover 400 to the mounting plate 105. As can be seen in FIGS. 4A-B, the side walls 410, in some examples, are located along the long or maximum dimension of the bottom cover 400. In more detail, the side walls 410 can extend from the body 405 in a vertical direction that is normal to the body 405. The side walls 410, in some examples, can have a height ranging from 7.85 mm to 8.15 mm. Additionally, the side walls 410 can be continuous or non-continuous, depending on a given application. When the bottom cover 400 is positioned onto the mounting plate 105, in some examples, the side walls 410 overlap the top cover 110. In some applications, the side walls 410 further include locking features 425 that engage the holes 325 of the top cover 110 to secure the two cover plates together. The locking features 425, in some examples, are raised features that engage or otherwise are inserted into the holes 325. In some other examples, the bottom cover 400 may not include side walls 410. Numerous other bottom cover configurations will be apparent in light of the present disclosure.

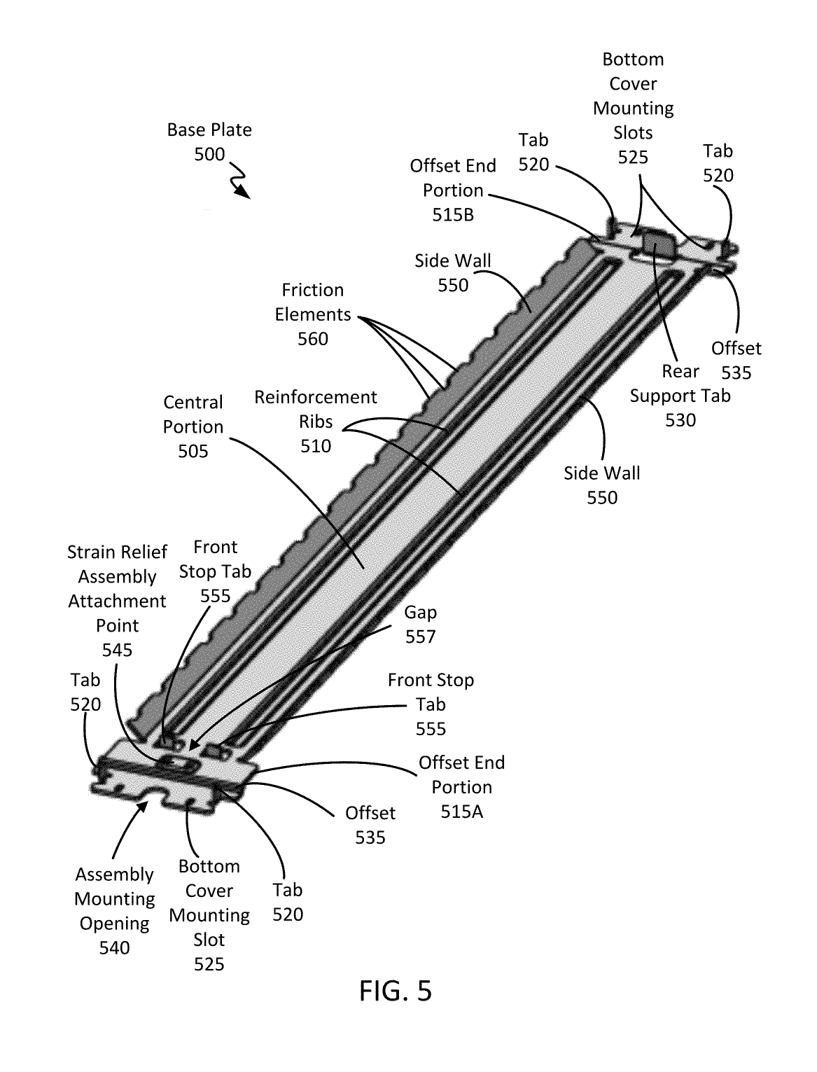

FIG. 5 is a perspective view of a battery mounting plate 500 for the battery pack 100 of FIG. 1A, in accordance with another embodiment of the present disclosure. In this one example, the mounting plate 500 includes a central portion 505, offset end portions 515A and 515B (collectively end portions 515) and side walls 550. The central portion 505, ends 515, and side walls 550 function and include features as those previously described in relation to the mounting plate 105 shown FIGS. 2A-B. In addition, the mounting plate 500 attaches to or otherwise interfaces with battery pack components, for example the top cover 110, in a similar fashion as the mounting plate 105, previously described herein. As can be seen, mounting plate 500 further includes front stop tabs 555 and friction elements 560 that further secure the battery assembly 130 to the mounting plate 500, as described below.

As can be seen, the mounting plate 500 includes front stop tabs 555 located at the end portion 515A opposite the end portion 515B that includes rear support tab 530. Together, front stop tabs 555, rear support tab 530, and wrapping 135, prevent movement of the battery assembly 130 relative to the mounting plate 500 in a direction along a length of the battery pack 100. In the example embodiment shown, two front stop tabs 555 are located at end portion 515A. The front stop tabs 555 are separated from one another by a gap 557, in which the wire harness 115 can pass through. The front stop tabs 555 extend vertically from a surface of the mounting plate 500 and contact one end of the battery assembly 130. Note that the height of the front stop tabs 555 above the mounting plate 500 can be less than the height of the rear support tab 530 so that the front stop tabs 555 do not contact or otherwise interfere the wiring harness 115. In some other examples, the mounting plate 500 may include a single front stop tab 555 at end portion 515A. In some such instances, the single front stop tab 555 can include a cut-out or opening in which to receive the wiring harness 115. In some further examples, the front stop tab 555 can include a grommet within the cut-out (or opening) to insulate or otherwise protect the wiring harness 115 as it passes through the front stop tab 555. Additionally, the front stop tabs 555 and rear support tab 530 assist with positioning the battery assembly 130 on the mounting plate 500. As shown, the front stop tabs 555 and rear support tab 530 are positioned parallel to one another so that the battery assembly 130 is positioned therebetween. In addition, the different configurations of the front stop tabs 555 and rear support tab 530 (e.g., two front stop tabs 555 versus a single rear support tab 530) provide a visual cue as to the manner in which to position the battery assembly 130 onto the mounting plate 500. For instance, in this one example, the gap 557 between front stop tabs 555 is configured to receive the wiring harness 115, as described above. Thus, the gap 557 visually indicates an orientation of the battery assembly 130 relative to the mounting plate 500 (e.g., battery assembly 130 positioned on mounting plate 500 with wiring harness 115 at end portion 515A).

In addition, in some example embodiments, the mounting plate 500 further includes a plurality of friction elements 560 disposed along the side walls 550. In general, the friction elements 560 provide additional surface area in which to contact the wrapping 135. Particularly, the friction elements 560 improve grip or attachment of the wrapping 135 to the mounting plate 500. For instance, friction elements 560 can be integrated into one edge of the side walls 550, as shown. The friction elements 560 can be a series of cut-outs (e.g., peaks and valleys) that increase the surface area of the side wall's edge. In some examples, the friction elements 560 can be in a form of a pattern (e.g., an alternating or repeating pattern) that is uniform or not, depending on the application. In other examples, the frictional elements 560 can be disposed along a portion of the side walls 550, so that the side walls 550 include one or more separate and distinct groups of friction elements 560. In addition, the friction elements 560 can be located on an outer surface. In such applications, the friction elements 560 can be raised features (e.g., tabs) that engage the wrapping 135 as the wrapping 135 is positioned around the side walls 550 of the mounting plate 500. Numerous other friction element configurations will be apparent in light of the present disclosure.

FIG. 6A is a block diagram of a light fixture 600 configured in accordance with an embodiment of the present disclosure. As previously described above, the battery pack of the present disclosure can provide power to any number of electric devices, including a light fixture. When connected to a light fixture as described herein, the light fixture is reconfigured to provide emergency lighting. The battery pack, as disclosed herein, is easily scalable to fit and power any existing light fixture. This is particularly noteworthy, because the battery pack of the present disclosure allows pre-existing light fixtures to be converted to emergency light fixtures without adding additional light fixtures to a structure (e.g., an office building or retail space), which can be cost prohibitive. As described above, the light fixture 600 can be any type of light fixture, such as troffers or flat panel lights, just to name a few light fixture examples. The light fixture 600, in some example embodiments, includes light sources 605, a driver 610, a power sensor 615, and a battery pack 625. The battery pack 625 has been previously described in relation to FIGS. 1-4. Note that the battery pack 625 can be installed internal or external to the light fixture 600. This is illustrated in FIG. 6A by the battery pack 625 appearing in dotted lines outside the light fixture 600.

The light fixture 600 includes one or more light sources 605 configured to produce and transmit light to an area about the fixture 600. The light sources 605, in some examples, can be fluorescent or incandescent lamps. In other examples, the light sources 605 can be solid-state light sources, such as light emitting diodes (LEDs). No matter their type, the light sources receive electrical power that is regulated by a driver 610 to promote light source efficiency and performance.

Connected to the light sources 605 is a driver 610 configured to regulate the electrical power transmitted thereto. Generally speaking, the driver 610 regulates the voltage and current supplied to the light sources 605 during startup of the light fixture 600 and throughout operation of the fixture 600. The driver 610 receives electrical power via an electrical power input from either a power panel (e.g., 110/277-line voltage from an electrical circuit) or the battery pack 625. In some examples, the driver 610 is an electrical (or electronic) ballast that regulates power to light sources 605 configured as fluorescent or incandescent lamps. In some other examples, the driver 610 is an electrical circuit that controls the electrical power transmitted to one or more solid-state light sources. In such a configuration, the driver 610 regulates the electricity transmitted to the solid-state light sources to prevent the light sources 605 from overheating and/or becoming unstable. Excessive heat can cause solid-state light sources to perform poorly or otherwise fail.

The light fixture also includes a power sensor 615 configured to monitor electrical power received by the light fixture 600. In general, the power sensor 615 measures the amount of incoming electricity received by the light fixture 600, for example by measuring voltage and/or current. In some examples, the power sensor 615 further includes a switch 620 that changes the source of electrical power for the driver 610. For instance, in response to identifying that the light fixture is no longer receiving electrical power from the power panel (due to a power outage), the power sensor 615 is configured to change the source of power from the power panel to the battery pack 625, for example by operating a switch 620. Once power is available from the power panel, the power sensor 615 is configured to re-position the switch 620 to change the source power for the driver from the battery pack 625 back to the power panel. Note that, in some examples, the power sensor 615 can be integrated into the driver 610 or battery pack 625. In such applications in which the sensor 615 is integrated into the driver 610, the driver 610 is connected to both the electrical power input from the power panel (e.g., an electrical circuit) and the battery pack 625. In some examples, the battery pack 625 can be configured as a rechargeable battery pack. In such examples, the battery pack 625 can receive electrical power from the electrical power input to charge the batteries of the pack 625. Numerous other light fixture configurations will be apparent in light of the present disclosure.

In other embodiments, such as shown in FIGS. 6B and 6C, the power sensor 615 is included or otherwise integrated within other components of the light fixture 600, for example, the battery pack 625 or driver 610. In such instances, in which the power sensor 615 is integrated into the battery pack 625, the battery pack 625 can be utilized to convert an existing light fixture within an area into an emergency light fixture without modification to the light fixture. In some examples, the power sensor 615 can be integrated within the battery assembly 130 and/or connected to the wiring harness 115 of the battery pack 625. The power sensor 615 can be secured to the mounting plate 105 (or 500) along with the battery assembly 130 using a wrapping 135, as previously described herein. In some other examples, the power sensor 615 and switch 620 are integrated into the driver 610 and the battery pack 625 is connected thereto. In such examples, the driver 610 is configured to determine a source of electrical power, for example from electrical input or battery pack 625, from which to operate the light fixture 600. Numerous other battery pack configurations will be apparent in light of the present disclosure.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A battery pack comprising:
a battery mounting plate having an elongated central portion and opposing offset end portions at each end of the elongated central portion, the central portion configured to receive one or more batteries and including a reinforcement rib, wherein the rib extends longitudinally along a length of the central portion of the mounting plate, and the offset end portions each including at least two bends that position a corresponding terminal portion of the mounting plate relative to the central portion;
a wrapping that attaches the one or more batteries to the mounting plate, wherein the wrapping surrounds at least a portion of the central portion of the mounting plate and at least a portion of the one or more batteries; and
a wiring harness connected to the one or more batteries and including a strain relief assembly, the assembly is configured to prevent the wiring harness from being separated from the one or more batteries.

2. The battery pack of claim 1, wherein the battery mounting plate is a single continuous plate and includes a plurality of reinforcement ribs that extend longitudinally along the length of the central portion of the mounting plate.

3. The battery pack of claim 1, wherein the reinforcement rib extends beyond the central portion of the mounting plate and into at least one of the opposing offset end portions of the mounting plate.

4. The battery pack of claim 3, wherein the length of the mounting plate is a maximum dimension of the battery pack.

5. The battery pack of claim 1, wherein the offset end portions include a first bend and a second bend, the first bend being in a first direction relative to the mounting plate and the second bend being in a second direction different from the first direction and relative to the mounting plate to position the corresponding terminal portion of the mounting plate in a first plane offset from but parallel to a second plane in which the central portion runs.

6. The battery pack of claim 5, wherein the offset end portions extend along a width of the battery pack.

7. The battery pack of claim 1, wherein the wrapping includes a first layer of wrapping and a second layer of wrapping, the first layer of wrapping surrounds the one or more batteries and the second layer of wrapping surrounds the first layer of wrapping and the central portion of the mounting plate.

8. The battery pack of claim 7, wherein the wrapping is shrink wrapping.

9. The battery pack of claim 7, wherein the wrapping includes two or more layers of wrapping, and each layer of wrapping is applied in a direction different than a direction of a previous layer.

10. The battery pack of claim 1, wherein the strain relief assembly includes a grommet and a fastening element with a portion of the wiring harness located therebetween, the strain relief assembly transmits an applied force along the wiring harness in a non-linear direction relative to the one or more batteries.

11. The battery pack of claim 1 further comprising a top cover attached to the mounting plate and positioned over the one or more batteries.

12. The battery pack of claim 11, further comprising a bottom cover attached to at least one of the mounting plate and the top cover, such that a portion of the bottom cover overlaps the top cover.

13. The battery pack of claim 12, wherein the bottom cover is in contact with the mounting plate and further includes a plurality of locking features configured to engage openings within the top cover to maintain the bottom cover in contact with the top cover.

14. The battery pack of claim 1, further comprising a power sensor to sense loss of main power and a switch to electrically connect the one or more batteries into a circuit so that one or more batteries can provide power.

15. A light fixture comprising:
a housing that includes one or more light sources;
a driver disposed within the housing and operatively coupled to the one or more light sources; and
a battery pack operatively coupled to the driver, the battery pack comprising:
a battery mounting plate having an elongated central portion and opposing offset end portions at each end of the elongated central portion, the central portion configured to receive one or more batteries and including a reinforcement rib, wherein the rib extends longitudinally along a length of the central portion of the mounting plate, and the offset end portions each including at least two bends that position a corresponding terminal portion of the mounting plate relative to the central portion;
a wrapping that attaches the one or more batteries to the mounting plate, wherein the wrapping surrounds at least a portion of the central portion of the mounting plate and at least a portion of the one or more batteries; and
a wiring harness connected to the one or more batteries and the driver, the wiring harness includes a strain relief assembly configured to prevent the wiring harness from being separated from the one or more batteries.

16. The light fixture of claim 15, wherein the battery pack further comprises a power sensor to sense loss of main power and a switch to electrically connect the one or more batteries into a circuit so that one or more batteries can provide power.

17. The light fixture of claim 15, wherein the battery mounting plate is a single continuous plate and includes a plurality of reinforcement ribs that extend longitudinally along the length of the central portion of the mounting plate.

18. The light fixture of claim 15, wherein the offset end portions include a first bend and a second bend, the first bend being in a first direction relative to the mounting plate and the second bend being in a second direction different from the first direction and relative to the mounting plate to position the corresponding terminal portion of the mounting plate in a first plane offset from but parallel to a second plane in which the central portion runs.

19. The light fixture of claim 15, wherein the strain relief assembly includes a grommet and a fastening element with a portion of the wiring harness located therebetween, the strain relief assembly transmits an applied force along the wiring harness in a non-linear direction relative to the one or more batteries.

20. The light fixture of claim 15, wherein the battery pack further comprises a bottom cover attached to the mounting plate and a top cover, such that a portion of the bottom cover overlaps the top cover.
